(19) United States
(12) Patent Application Publication
(10) Pub. No.: US 2018/0113667 A1
(43) Pub. Date: Apr. 26, 2018

(54) Synchronous Digital Telegraphy

(71) Applicants: Jason Kiswanto, Diamond Bar, CA (US); Cihan Inam, Diamond Bar, CA (US)

(72) Inventors: Jason Kiswanto, Diamond Bar, CA (US); Cihan Inam, Hacienda Heights, CA (US)

(73) Assignee: Regal Rapscallion, Diamond Bar, CA (US)

(21) Appl. No.: 15/334,288

(22) Filed: Oct. 26, 2016

(51) Int. Cl. G06F 3/14; G06F 3/0488; H04L 29/06; H04L 12/18

(52) U.S. Cl. CPC G06F 3/1454; H04L 12/185; H04L 65/4015; G06F 3/04883

(57) ABSTRACT

A system of communication using touch screens to convey user-defined illustrations. The touch screens are reversible such that any touch screen can accept illustrations that will be subsequently displayed in real-time on all connected touch screens without relying upon a hierarchy. Multiple touch screens may share a common operable view in a secure manner.

### TECHNOLOGICAL FIELD

The embodiments described herein generally relate to the field of telecommunication.

### BACKGROUND

The field of telecommunication has risen rapidly recently with advances in smartphones, social media, streaming videos, and the like. These advances have enabled an unprecedented array of communication forms and the attendant benefits and advantages of said communication forms. However, along with said benefits and advantages, said communication forms have also introduced drawbacks and disadvantages.

Some of these drawbacks and disadvantages include a lack of privacy, a reliance upon a central provider/server, and being confined within prescribed communication schemes.

Privacy has been a main concern of telecommunication due to the nature of the transmission medium being susceptible to being tapped between the origin and destination. Attempts to address this privacy concern has included various encryption schemes, such as RSA, two-factor authentication, etc. However, said encryption schemes require significant resources to implement and are at times overly burdensome for the task required.

Lack of privacy is also related to the reliance upon a central server in almost all media of telecommunication. The central server's role in handling all traffic of a particular medium is problematic since said handling requires storage of various data, which is susceptible to a hack compromising the data of all users of a particular medium. There is also no guarantee that the provider of the central server will respect the user's privacy and take care of the data that is processed within the central server with the care required to ensure said privacy. The central nature of the server would also render the respective communication unavailable if the central server were to go offline for any reason.

Finally, contemporary telecommunication is oftentimes confined to the prescribed communication scheme within the respective medium. For example, when using emojis, a user is limited to the selection of available emojis.

### DESCRIPTION OF DRAWINGS

FIG. 1 depicts two touch screens sharing a canvas element according to an embodiment of the invention.

FIG. 2 depicts four touch screens of different resolutions sharing a canvas element according to an embodiment of the invention.

FIG. 3A depicts a step in an operational sequence of touch screens sharing a canvas element according to an embodiment of the invention.

FIG. 3B depicts a step in an operational sequence of touch screens sharing a canvas element according to an embodiment of the invention.

FIG. 3C depicts a step in an operational sequence of touch screens sharing a canvas element according to an embodiment of the invention.

FIG. 3D depicts a step in an operational sequence of touch screens sharing a canvas element according to an embodiment of the invention.

FIG. 3E depicts a step in an operational sequence of touch screens sharing a canvas element according to an embodiment of the invention.

FIG. 3F depicts a step in an operational sequence of touch screens sharing a canvas element according to an embodiment of the invention.

FIG. 3G depicts a step in an operational sequence of touch screens sharing a canvas element according to an embodiment of the invention.

FIG. 3H depicts a step in an operational sequence of touch screens sharing a canvas element according to an embodiment of the invention.

FIG. 3I depicts a step in an operational sequence of touch screens sharing a canvas element according to an embodiment of the invention.

FIG. 3J depicts a step in an operational sequence of touch screens sharing a canvas element according to an embodiment of the invention.

FIG. 4 depicts a block diagram of an exemplary touch screen used within embodiments of the invention.

### DETAILED DESCRIPTION

The following description sets forth exemplary methods, parameters, and the like. It should be recognized, however, that such description is not intended as a limitation on the scope of the present disclosure but is instead provided as a description of exemplary embodiments

Although the following description uses terms “first”, “second”, etc. to describe various elements, these elements should not be limited by the terms. These terms are only used to distinguish one element from another. For example, a first touch could be termed a second touch and a second touch could be termed a first touch, without departing from the scope of the various described embodiments.

Embodiments of electronic devices, user interfaces for such devices, and associated processes for using such devices are described. In the discussion that follows, an electronic device that includes a display and a touch-sensitive surface is described. It should be understood, however, that the electronic device optionally includes one or more other physical user-interface devices, such as a mouse, joystick, trackpad, trackball, and/or any cardinality or orientation-based input device.

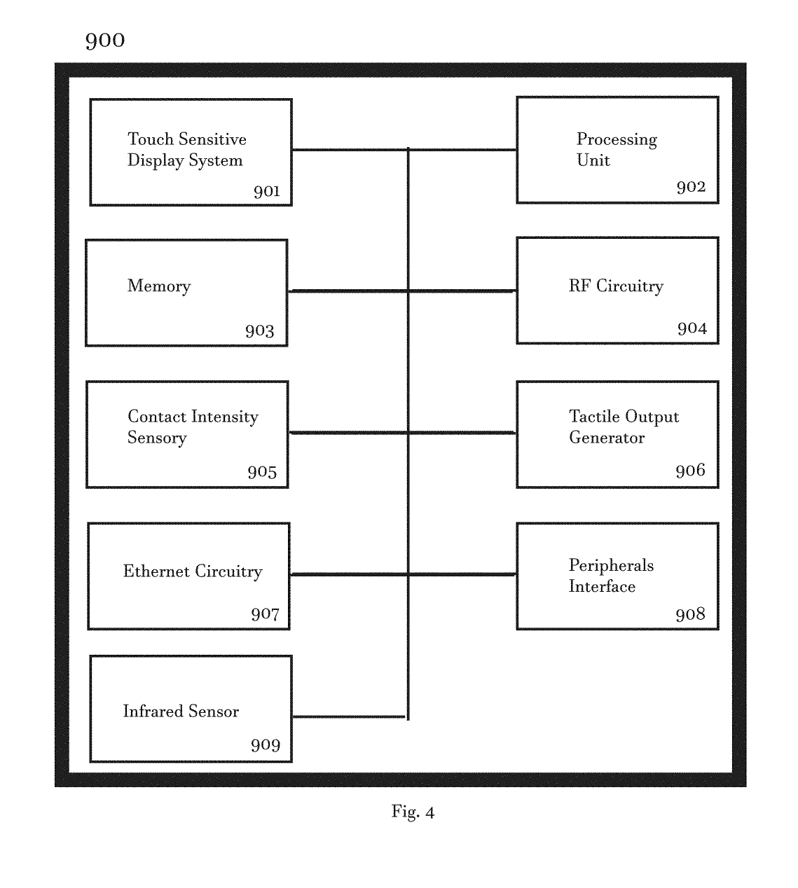

Attention is now directed toward embodiments of portable devices with touch-sensitive displays. FIG. 4 depicts device 900 with touch-sensitive display system 901 in accordance with some embodiments. Touch-sensitive display system 901 is sometimes called a “touch screen” for convenience. Device 900 includes memory 903, one or more processing units (CPUs) 902, peripherals interface 910, RF circuitry 904, speaker 907, microphone 908. Device 100 optionally includes one or more contact intensity sensors 905 for detecting intensity of contacts on touch screen 901. Device 900 optionally includes one or more tactile output generators 906 for generating tactile outputs on device 900 (e.g., generating tactile outputs on a touch-sensitive surface such as touch screen 901). These components optionally communicate over one or more communication buses or signal lines 911.

It should be appreciated that device 900 is only one example of a portable multifunction device, and that device 900 optionally has more or fewer components than shown, optionally combines two or more components, or optionally has a different configuration or arrangement of the components. The various components shown in FIG. 4 are implemented in hardware, software, or a combination of both hardware and software, including one or more signal processing and/or application-specific integrated circuits.

Memory 903 may include one or more computer-readable storage mediums. The computer-readable storage mediums may be tangible and non-transitory. Memory 903 may include high-speed random access memory and may also include non-volatile memory, such as one or more magnetic disk storage devices, flash memory devices, or other non-volatile solid-state memory devices.

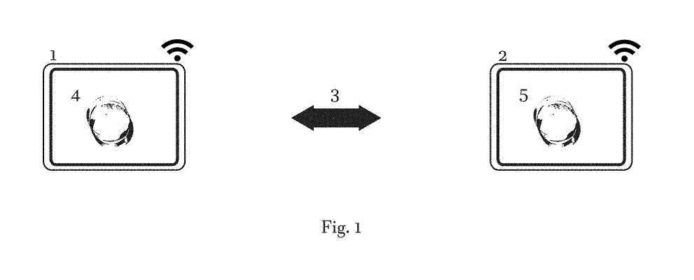

Attention is now directed to FIG. 1, which illustrates two touch screens 1, 2 as part of respective devices in accordance with the embodiment described above, in communication with each other. Touch screens 1, 2 are connected to each other via a direct connection 3, using, but not limited to, TCP/IP or UDP. Touch screens 1, 2 may initiate connection 3 through their respective RF circuitry 904. Once connection 3 is initiated, touch screens 1, 2 are able to share a common operable view, as seen in on-screen objects 4 and 5. The common operable view may be implemented by an HTML canvas element. On-screen objects 4 and 5 are commonly displayed by touch screens 1, 2 and also commonly operable such that a user of touch screen 1 can operate on object 4 and have the resultant operations be reflected on object 5 of touch screen 2, while a user of touch screen 2 can operate on object 5 and have the resultant operations be reflected on object 4 of touch screen 1.

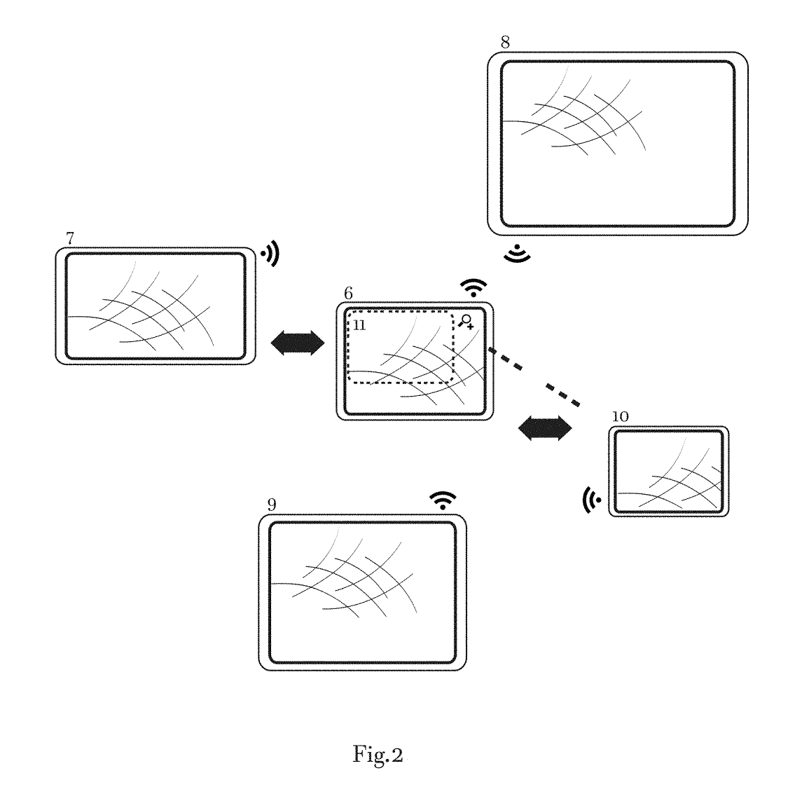

Attention is now directed to FIG. 2, which illustrates an embodiment of the invention with more than two touch screens in connection, sharing a canvas element. Touch screens 7, 8, 9, and 10 are touch screens in accordance with the description with respect to FIG. 1 above. Canvas element 6 is an internet object which touch screens 7, 8, 9, and 10 are tuned into such that said touch screens are effectively sharing a single display. As can be seen in FIG. 2, canvas element 6 is configured such that the respective displays of touch screens 7-10 reflect an instantaneous state of the canvas element 6. Moreover, any of the touch screen 7-10 can manipulate the canvas element 6 with a touch operation and said touch operation will be viewed by all touch screens tuned into canvas element 6 in real time. Each touch screen receives access to the canvas element 6 and takes any touch operation done to its respective screen and applies them to the canvas element 6. Since the other touch screens are accessing the canvas element 6, said other touch screens are able to see the changes made to the canvas element 6 by any other touch screen while maintaining the ability to apply touch operations to the canvas element 6 itself also, resulting in a “reversible display”.

Touch operations may have attributes such as line type, color, and line width. An operator of a touch screen may then illustrate any 2D object on his touch screen without limitations on format, etc. Any other touch screen sharing a common canvas element with the operator's touch screen will reflect the illustrated 2D object in real time. Said other touch screen can then illustrate another 2D object or append to the original 2D object or delete any part of the original 2D object, or any other operations that the touch screen is capable of supporting.

The canvas element is further not limited by the frame or resolution of a particular touch screen. As seen in FIG. 2, touch screen 10 is a comparatively smaller touch screen than the other touch screens 7-9. Touch screen 10 accesses a smaller portion of the overall canvas element 6, as denoted by box 11, while larger touch screens 7-9 can view a larger portion of the overall canvas element 6.

As can be seen in FIG. 2, the touch screen 7-10 connect directly to the canvas element 6 and/or each other without the necessity of a central server. This permits a more secure medium of communication while keeping computing costs low as well. Note that there can be many unique canvas elements that a touch screen can access. A particular touch screen is not limited to accessing a particular canvas element and instead can select from a multitude of canvas elements available “in the wild” to access as a form of “channel”.

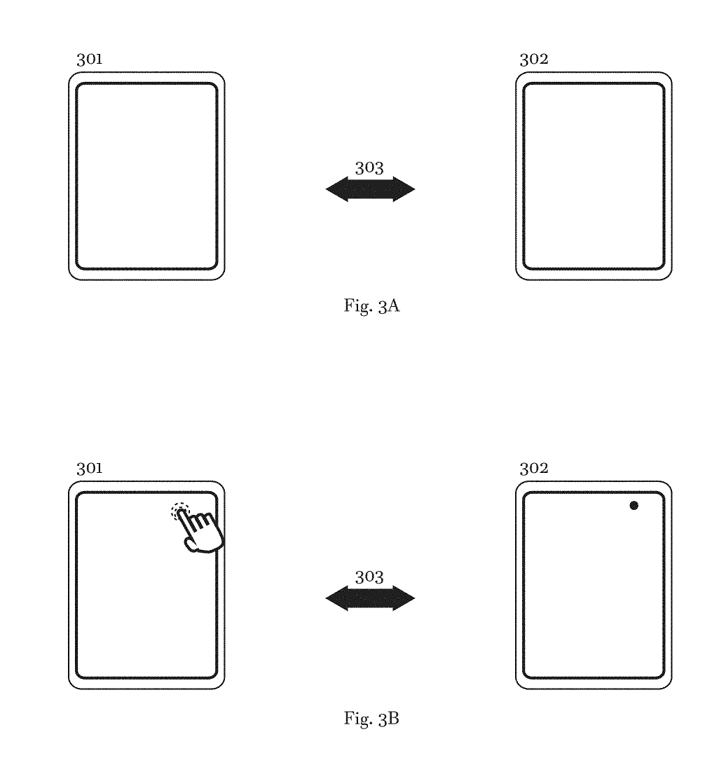

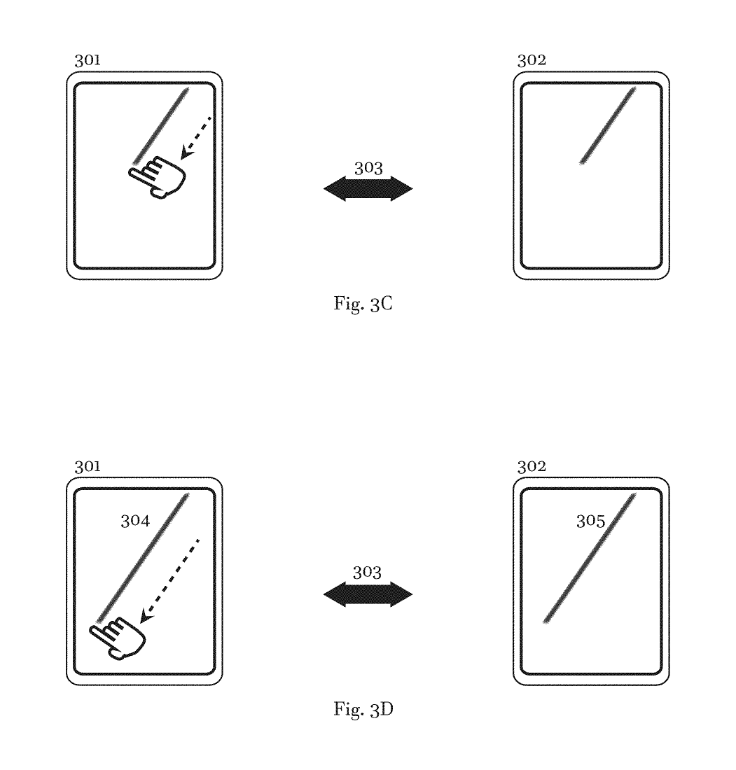

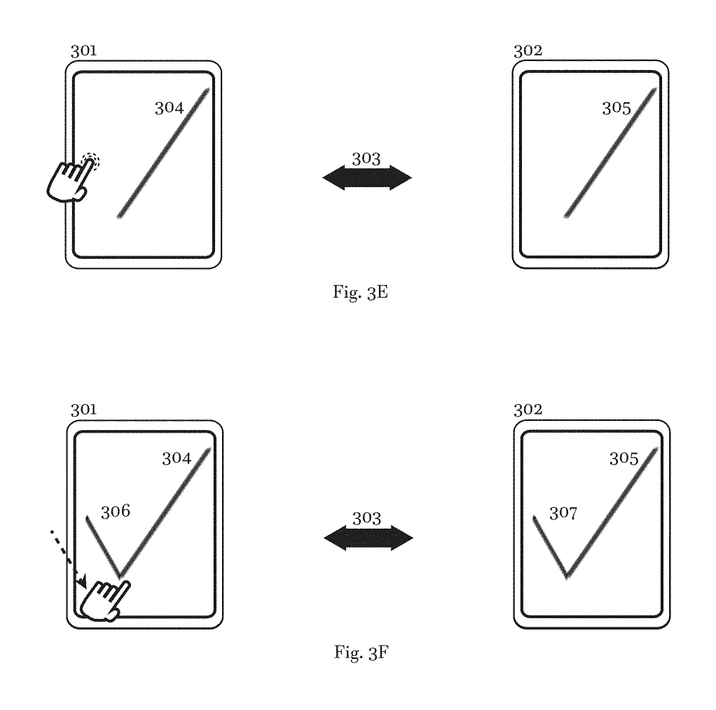

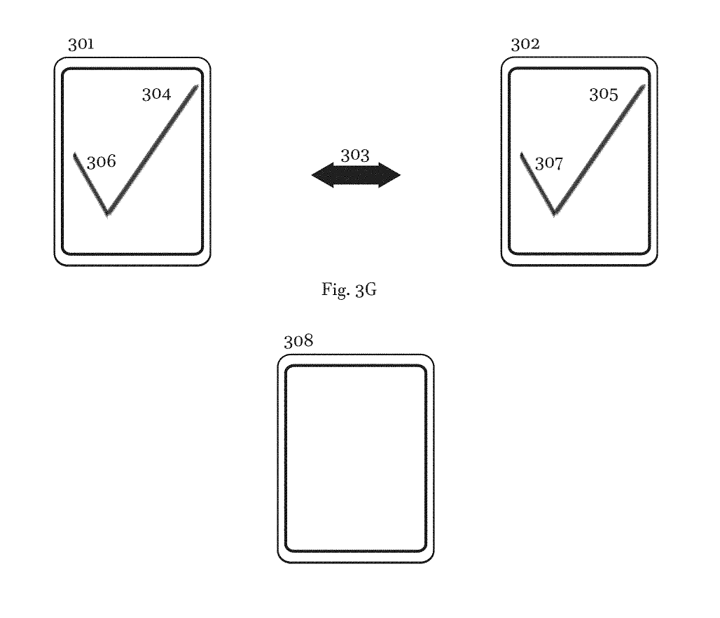

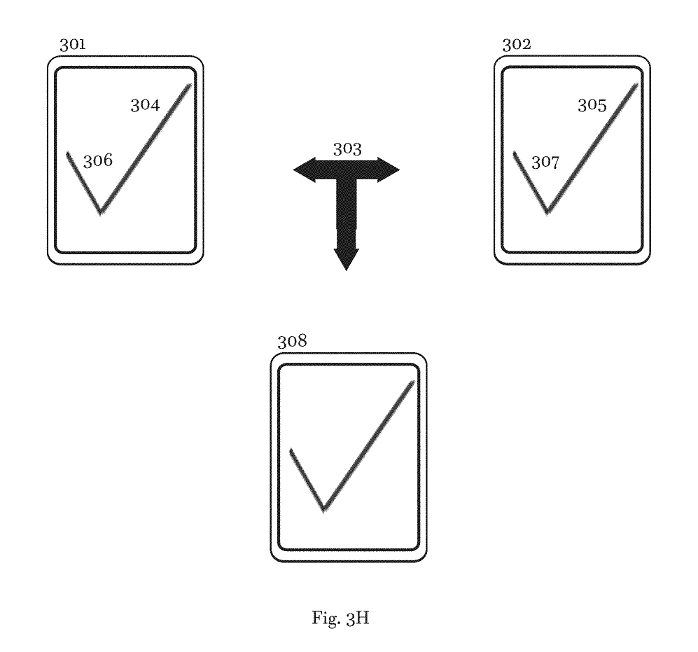

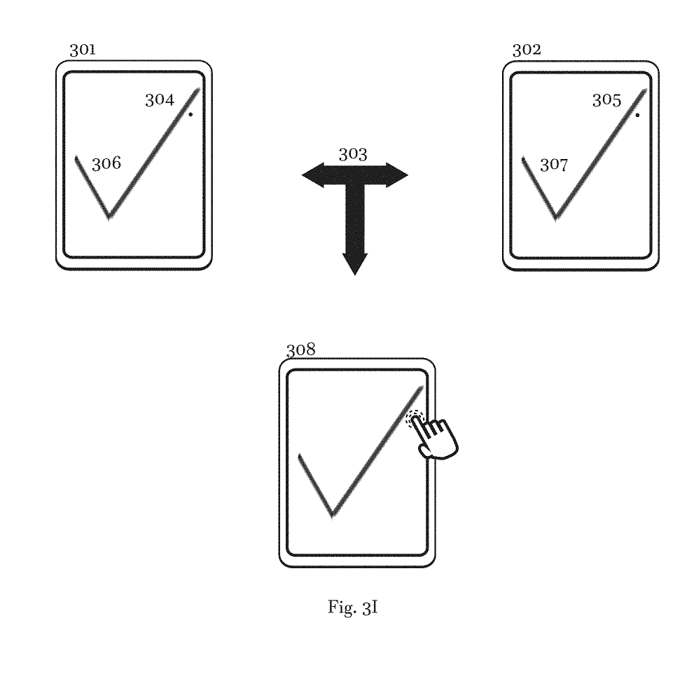

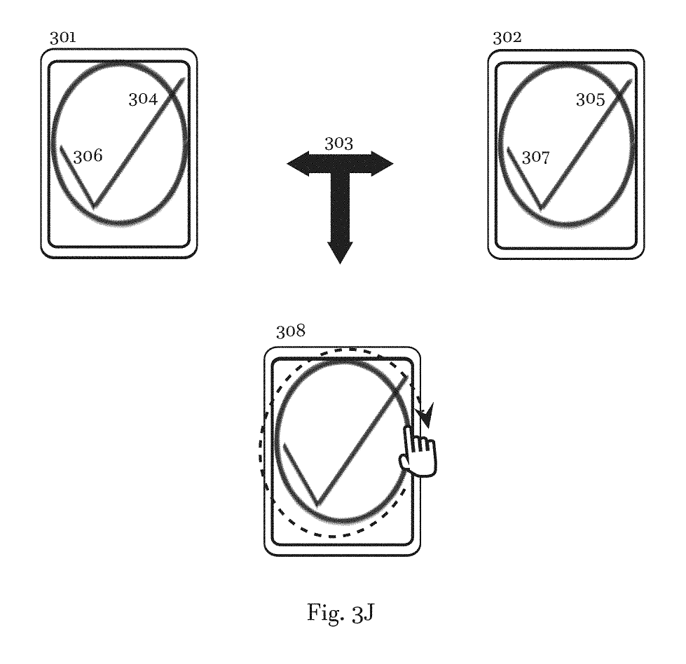

Attention is now directed to FIG. 3, which illustrates an operational process of the invention. FIG. 3A shows two touch screen devices 301 and 302 with a TCP/IP connection 303 between them, similar to the configuration seen in FIG. 4 above. Touch screens 301, 302 are shown in this particular scenario as having blank screens, however that is for illustrative purposes only; said screens may have any graphical elements. FIG. 3B shows a user initiating a touch operation on touch screen 301 at an initial point of touch. This initial touch is reflected on touch screen 302 as a dot at the corresponding location of the initial touch on touch screen 301. FIGS. 3C and 3D show the user subsequently performing a touch operation on touch screen 301 in the form of a diagonal gesture from the initial point of touch to a lower-left region, which results in congruent line 304 and 305 being displayed simultaneously upon touch screens 301 and 302. FIG. 3C illustrates the simultaneous, real-time displaying of the touch operation upon all touch screens sharing a common canvas element. As the user traces his finger upon the touch screen 301, touch screen 302 simultaneously displays the gestured line that the user traces.

FIGS. 3E-F show a subsequent second touch operation occurring after the completion of the touch operation in FIG. 3B-D, this time performed on touch screen 302, in the form of a diagonal gesture from an upper-left region to a lower-right region, which results in another congruent line 306 and 307 being displayed simultaneously upon touch screens 301 and 302. This illustrates the “reversible” nature of the invention, such that an operation on any touch screen can instantaneously affect the display of any other touch screen sharing a common canvas element.

Next, FIG. 3G shows a third touch screen 308 that is not currently connected to touch screens 301, 302. Touch screen 308 has a blank screen because it has not accessed the canvas element (not shown) shared between touch screens 301, 302, yet. FIG. 3H shows the moment touch screen 308 initiates a connection with touch screens 301, 302, thus accessing the shared canvas element, which touch screen 308 now displays. FIG. 3I shows a touch operation being initiated on touch screen 308 in the form of a black dot shared with touch screens 301 and 302. Figure J shows a shared drawn element. As before, all other touch screens sharing the connection 303, in this case touch screens 301 and 302, display the circle 309, which was initially drawn on touch screen 308 by a touch operation. It should also be known that the number of touch screens and touches are not limited to three or one, respectively, but rather any number of touch screens may share a connection and thus, a canvas element.

### INDUSTRIAL APPLICABILITY

One of the biggest advantages of the device is the ability to communicate amongst one or multiple devices through a common point of interest, similar to that of a channel or frequency. This differs in many of the modern communication devices currently because it does not require the receiving party or parties to accept the incoming message such as that in a telephone call, text message, or emails. This allows for an abundant amount of new methods for improvements and optimization for various industries and such as that of: education, medical, military, telecommunications, and general work flow.

In terms of education the invention creates a huge enhancement to an educator's ability to share information and communicate to and from the students in a nonintrusive or misinterpreted vocalized manner. While there are many barriers for children to vocalize their concerns, due to things such as language, insecurity issues, and physical or mental disabilities, the devices allows for the possibility of the brain to come to a new understanding of what communication means through giving children the availability to communicate in an illustrated fashion in their early stage of development.

Military poses a huge benefit through secure or private means of communication through the inherent design of the capacity in which a group of individuals in a proximity of about 200 feet can create a small network amongst themselves after once creating the connectivity of each individual of the group then to break away from the ISP. The same can be done amongst social groups and special interests groups alike, staying in the proximity of the wireless signal of each connected device, the group can allow for the connection to exist without a centralized server. Creating a decentralized network or an “internet dimension”.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not limited by the foregoing details, but rather is to be defined by the scope of the appended claims.

1. A system of communication comprising:
a first touch screen;
a second touch screen;
wherein the first touch screen and the second touch screen share a canvas element;
wherein a touch operation on either touch screen updates the canvas element such that the updated canvas element is displayed upon the first touch screen and the second touch screen.

2. The system of communication according to claim 1, further comprising: a TCP/IP or UDP connection between the first touch screen and the second touch screen.

3. The system of communication according to claim 1, further comprising: no server.

4. The system of communication according to claim 1, further comprising: at least one additional touch screen, sharing the canvas element.

5. The system of communication according to claim 1, further comprising: at least one additional canvas element being shared by the touch screens.

6. The system of communication according to claim 1, wherein the updated canvas element is displayed in real-time.

7. The system of communication according to claim 1, wherein the canvas element comprises a 2D illustration.

8. The system of communication according to claim 7, wherein the touch operation updates the canvas element such that the 2D illustration is updated.

9. The system of communication according to claim 1, wherein the touch operation comprises a gesture, the updated canvas element thus comprising a 2D element substantially congruent with said gesture, said 2D element being displayed upon the first touch screen and the second touch screen.

10. The system of communication according to claim 1, wherein the canvas element is not resolution limited by any touch screen.

11. A non-transitory computer-readable medium comprising instructions that, when executed by a computer, performs the steps of:
sharing a canvas element with a first touch screen and a second touch screen,
detecting a touch operation at either touch screen,
updating the canvas element in accordance with said touch operation,
displaying the updated canvas element on the first touch screen and the second touch screen.

12. The non-transitory computer-readable medium of claim 11, further comprising instructions to perform the step of: connecting the first touch screen and the second touch screen via a TCP/IP or UDP connection.

13. The non-transitory computer-readable medium of claim 11, further comprising: the absence of instructions regarding a server.

14. The non-transitory computer-readable medium of claim 11, further comprising instructions to perform the step of: sharing the canvas element with at least one additional touch screen.

15. The non-transitory computer-readable medium of claim 11, further comprising instructions to perform the step of: sharing at least one additional canvas element with the first touch screen and the second touch screen.

16. The non-transitory computer-readable medium of claim 11, further comprising instructions to perform the step of: displaying the canvas element in real-time.

17. The non-transitory computer-readable medium of claim 11, further comprising instructions to perform the step of: illustrating a 2D element.

18. The non-transitory computer-readable medium of claim 17, further comprising instructions to perform the step of: updating the 2D element when the canvas element is updated.

19. The non-transitory computer-readable medium of claim 11, further comprising instructions to perform the steps of: recognizing the touch operation as a gesture, wherein updating the canvas element comprises illustrating a 2D element substantially congruent with said gesture, and wherein displaying the updated canvas element comprises said 2D element being displayed upon the first touch screen and the second touch screen.

20. The non-transitory computer-readable medium of claim 11, further comprising instructions to perform the step of: not limiting the canvas element by a resolution of any touch screen.
